(19) United States
(12) Patent Application Publication
(10) Pub. No.: US 2026/0179383 A1
(43) Pub. Date: Jun. 25, 2026

(54) MONITORING APPARATUS, MONITORING METHOD, AND NON-TRANSITORY COMPUTER-READABLE MEDIUM

(71) Applicant: NEC Corporation, Minato-ku, Tokyo (JP)

(72) Inventor: Masumi ISHIKAWA, Tokyo (JP)

(73) Assignee: NEC Corporation, Minato-ku, Tokyo (JP)

(21) Appl. No.: 18/856,914

(22) PCT Filed: Apr. 25, 2022
(86) PCT No.: PCT/JP2022/018772

§ 371 Date: Oct. 15, 2024

(51) Int. Cl. H04N 7/18; G06V 20/52; G06V 40/10

(52) U.S. Cl. CPC G06V 20/52; G06V 40/10

(57) ABSTRACT

A monitoring apparatus (100) includes a timetable acquisition unit (102) that acquires an estimated arrival time of a public transportation means at a boarding station of the public transportation means, and a control unit (104) that controls at least one of a camera being installed at the boarding station and a processing frequency of a first image being generated by the camera, by using the estimated arrival time.

### TECHNICAL FIELD

The present invention relates to a monitoring apparatus, a monitoring method, and a storage medium.

### BACKGROUND ART

In recent years, since labor saving at a boarding station of a public transportation means has been advanced, it is required to ensure safety and security of a user using such a boarding station.

A support apparatus for ensuring operational safety, such as monitoring a station platform and responding to falls, which were a duty of a station staff, is described in Patent Document 1. According to the apparatus in this document, an infrared sensor is installed on a railroad and it is possible to issue an alert regarding danger to an operator of an approaching train by emitting light from a special light-emitting signal device in a case where a passenger falls from a platform or the like, and a push button is installed on the platform and it is possible to also issue an alert regarding the danger from the platform by emitting light from the special light-emitting signal device.

Patent Document 2 describes a station service remote monitor system being capable of reducing work time and labor of an operator, which are required for starting and stopping station equipment, and securely executing a remote operation. In this system, an item file that indicates control for various types of equipment (an automatic ticket gate, an automatic ticket vending machine, an automatic fare adjustment machine, an elevator, an escalator, an electric shutter, and the like) at an unmanned station at the beginning and end of operations is associated with a time for each day of the week, and is stored as schedule data in a control terminal at a center station. Further, at timing at which the time being set in the schedule data arrives, the control terminal executes the control for the equipment associated with the time according to the schedule data. Further, the control is executed not only for equipment within an own station but also for various types of equipment in a local station by transmitting an operation code to the equipment via a local area network (LAN), then monitoring whether the control is executed as specified by the schedule data is executed, and a retry is executed in a case where monitoring is not executed accordingly.

Patent Document 3 describes a monitoring system that displays, on a monitor of a center-side operation machine, a video of an unmanned station being imaged by a surveillance camera. While a video of each station is automatically switched at a predetermined time interval in a normal mode, switching is executed in response to an event associated with a train arrival at an unmanned station in such a way as to display a video of the station on the monitor, and the display returns to a normal switching mode after a certain time elapses. With this, a video before and after an arrival time of a train that requires particularly enhanced monitoring at the center can automatically be displayed.

### RELATED DOCUMENTS

### Patent Documents

Patent Document 1: Japanese Patent Application Publication No. 2002-362365
Patent Document 2: Japanese Patent Application Publication No. 2000-217162
Patent Document 3: Japanese Patent Application Publication No. 2002-238046

### SUMMARY OF INVENTION

### Technical Problem

In the above-mentioned techniques described in Patent Documents relate to a safe train operation such as detection of an object fallen onto a railroad or the like, control of facility equipment at an unmanned station, and enhancing of monitoring before and after a train arrival. Thus, in the above-mentioned technique described in Patent Documents, protecting safety of a user from a criminal act or the like in a space of an “unmanned station” is not anticipated. In view of this, the inventor of the present invention considered ensuring safety and security of a user at an unmanned station.

In view of the above-mentioned problem, one example of an object of the present invention is to provide a monitoring apparatus, a monitoring method, and a storage medium that secure safety and security of a user at an unmanned boarding station at a low cost in an efficient and effective manner.

### Solution to Problem

According to one aspect of the present invention, there is provided a monitoring apparatus including:
a timetable acquisition unit that acquires an estimated arrival time of a public transportation means at a boarding station of the public transportation means; and
a control unit that controls at least one of a camera being installed at the boarding station and a processing frequency of a first image being generated by the camera, by using the estimated arrival time.

According to one aspect of the present invention, there is provided a monitoring method including,
by one or more computers:
   acquiring an estimated arrival time of a public transportation means at a boarding station of the public transportation means; and
   controlling at least one of a camera being installed at the boarding station and a processing frequency of a first image being generated by the camera, by using the estimated arrival time.

According to one aspect of the present invention, there is provided a computer-readable storage medium storing a program for causing a computer to execute:
a procedure of acquiring an estimated arrival time of a public transportation means at a boarding station of the public transportation means; and
a procedure of controlling at least one of a camera being installed at the boarding station and a processing frequency of a first image being generated by the camera, by using the estimated arrival time.

Note that, according to another aspect of the present invention, there may be provided a program causing at least one or more computers to execute the method according to the one aspect, or there may be provided a computer-readable storage medium storing such a program. The storage medium includes a non-transitory and tangible medium.

The computer program includes, at a time of being executed by a computer, a computer program code causing the computer to execute the monitoring method on the monitoring apparatus.

Note that, any combination of the above-mentioned constituent elements, and a matter acquired by converting an expression of the present invention between a method, an apparatus, a system, a storage medium, a computer program, and the like are also effective as an aspect of the present invention.

Further, various constituent elements of the present invention are not necessarily independent entities, and it is possible that a plurality of constituent elements may be formed as a single member, one constituent element may be formed from a plurality of members, a certain constituent element may be part of another constituent element, or a part of a certain constituent element and a part of another constituent element may overlap with each other, and the like.

Further, a plurality of procedures are described in order in the method and the computer program according to the present invention, but the order thereof in the description is not intended to limit the order of executing the plurality of procedures. Thus, in a case where the method and the computer program according to the present invention are executed, the order of the plurality of procedures can be changed within a range that does not affect the contents.

Moreover, the plurality of procedures of the method and the computer program according to the present invention are not limited to being executed at distinct timing. Therefore, it is acceptable that a certain procedure occurs during execution of another procedure, some or all of execution timing of a certain procedure and execution timing of another procedure overlap with each other, and the like.

### Advantageous Effects of Invention

According to one aspect of the present invention, it is possible to acquire a monitoring apparatus, a monitoring method, and a storage medium that secure safety and security of a user at an unmanned boarding station at a low cost in an efficient and effective manner.

### BRIEF DESCRIPTION OF THE DRAWINGS

FIG. 1 It is a diagram illustrating an overview of a monitoring apparatus according to an example embodiment.

FIG. 2 It is a flowchart illustrating an operation example of the monitoring apparatus according to the present example embodiment.

FIG. 3 It is a diagram schematically illustrating a system configuration of a monitoring system 1 according to the example embodiment.

FIG. 4 It is a block diagram illustrating a hardware configuration of a computer that implements the monitoring apparatus of the example embodiment.

FIG. 5 It is a diagram illustrating a data structure example of camera information.

FIG. 6 It is a diagram illustrating a control example of imaging timing of a camera by a control unit of the monitoring apparatus of the example embodiment.

FIG. 7 It is a functional block diagram illustrating a logical configuration example of the monitoring apparatus of the example embodiment.

FIG. 8 It is a diagram illustrating an example of a monitoring screen displayed by a display apparatus.

FIG. 9 It is a flowchart illustrating an operation example of the monitoring apparatus of the example embodiment.

FIG. 10 It is a flowchart illustrating a detailed procedure example of control processing by the control unit of the monitoring apparatus of the example embodiment.

FIG. 11 It is a functional block diagram illustrating a logical configuration example of the monitoring apparatus of the example embodiment.

FIG. 12 It is a diagram schematically illustrating a system configuration of the monitoring system 1 according to the example embodiment.

FIG. 13 It is a flowchart illustrating a detailed procedure example of the control processing by the control unit of the monitoring apparatus of the example embodiment.

FIG. 14 It is a functional block diagram illustrating a logical configuration example of the monitoring apparatus of the example embodiment.

FIG. 15 It is a flowchart illustrating an operation example of the monitoring apparatus of the example embodiment.

FIG. 16 It is a functional block diagram illustrating a logical configuration example of the monitoring apparatus of the example embodiment.

FIG. 17 It is a flowchart illustrating an operation example of the monitoring apparatus of the example embodiment.

FIG. 18 It is a diagram illustrating a control example of imaging timing of the camera by the control unit of the monitoring apparatus of the example embodiment.

FIG. 19 It is a functional block diagram illustrating a logical configuration example of the monitoring apparatus of the example embodiment.

FIG. 20 It is a diagram schematically illustrating a system configuration of the monitoring system according to the example embodiment.

FIG. 21 It is a diagram illustrating a display example of the monitoring screen.

FIG. 22 It is a diagram illustrating a display example of the monitoring screen.

FIG. 23 It is a diagram illustrating a data structure example of priority order information and level-based control information.

### EXAMPLE EMBODIMENT

Example embodiments of the present invention are described below with reference to the drawings. Note that, in all the drawings, a similar constituent element is denoted with a similar reference sign, and description therefor is not included as appropriate. Further, in each of the following drawings, a configuration of a portion that does not affect the essence of the present invention is not included, and is not illustrated.

In the example embodiments, “acquisition” includes at least one of retrieval of data or information being stored in another apparatus or a storage medium by an own apparatus (active acquisition), and an input of data or information being output from another apparatus to an own apparatus (passive acquisition). Examples of the active acquisition include sending a request or an inquiry to another apparatus and receiving a response, accessing and reading out another apparatus or a storage medium, and the like. Further, examples of the passive acquisition include receiving information being distributed (transmitted, push-notified, or the like), and the like. Moreover, “acquisition” may refer to selecting and acquiring a piece of data or information being received, or selecting and receiving a piece of data or information being distributed.

### Minimum Configuration Example

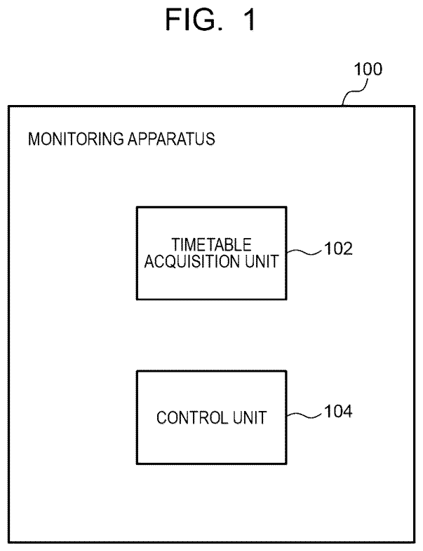

FIG. 1 is a diagram illustrating an overview of a monitoring apparatus 100 according to an example embodiment. The monitoring apparatus 100 includes a timetable acquisition unit 102 and a control unit 104.

The timetable acquisition unit 102 acquires an estimated arrival time of a public transportation means at a boarding station of the public transportation means.

The control unit 104 controls at least one of a camera being installed at the boarding station and a processing frequency of an image (first image) being generated by the camera, by using the estimated arrival time.

Herein, the first image is an image being generated by a camera 5a at a certain station 30a, and a second image, which is described in an example embodiment described later, is an image being generated by a camera 5b at another station 30b. Hereinafter, it will be simply referred to as “image” in a case where no specific distinction therebetween is required.

### Operation Example

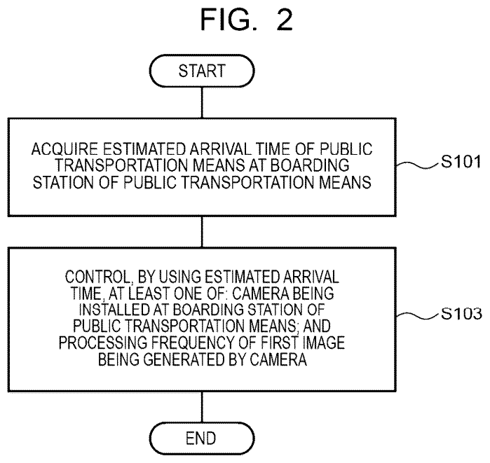

FIG. 2 is a flowchart illustrating an operation example of the monitoring apparatus 100 of the present example embodiment.

The timetable acquisition unit 102 acquires an estimated arrival time of a public transportation means at a boarding station of the public transportation means (step S101).

The control unit 104 controls at least one of a camera being installed at the boarding station and a processing frequency of an image (first image) being generated by the camera, by using the estimated arrival time (step S103).

According to the monitoring apparatus 100, it is possible to secure safety and security of a user at a boarding station of a public transportation means at a low cost in an efficient and effective manner.

A detailed example of the monitoring apparatus 100 is described below.

### First Example Embodiment

### <System Overview>

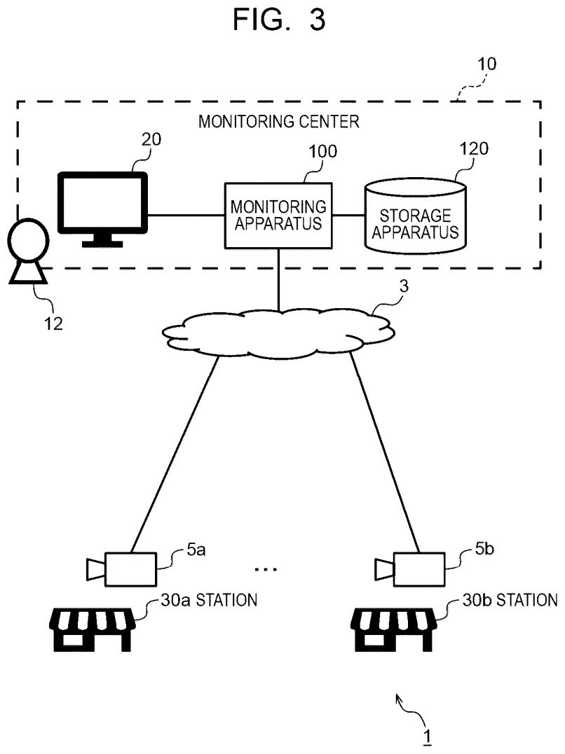

FIG. 3 is a diagram schematically illustrating a system configuration of a monitoring system 1 according to an example embodiment.

The monitoring system 1 includes a monitoring apparatus 100 and cameras 5a and 5b (hereinafter, it will be also simply referred to as “camera 5”, in a case where no specific distinction therebetween is required) that are installed at stations 30a and 30b (hereinafter, it will be also simply referred to as “station 30”, in a case where no specific distinction therebetween is required), respectively.

The camera 5 includes a lens and an imaging element such as a charge coupled device (CCD) image sensor, and is a network camera such as an internet protocol (IP) camera. For example, the network camera includes a wireless local area network (LAN) communication function, and is connected to the monitoring apparatus 100 via a relay apparatus (not shown) such as a router of a communication network 3. Further, the camera 5 may include a mechanism that performs control of an orientation of the camera main body or the lens, zoom control, focusing, and the like by tracking movement of a monitoring target.

An image to be generated by the camera 5 is preferably photographed in a real time and transmitted to the monitoring apparatus 100. However, an image to be transmitted to the monitoring apparatus 100 may not be transmitted directly from the camera 5, and may be an image delayed by a predetermined time. An image being photographed by the camera 5 may temporarily be stored in another storage apparatus (not shown), and may be read from the storage apparatus by the monitoring apparatus 100 successively or at a predetermined interval. Moreover, the image to be transmitted to the monitoring apparatus 100 is preferably a moving image, but may be a frame image at a predetermined interval, or may be a still image.

The monitoring apparatus 100 is a server computer or the like. The monitoring apparatus 100 includes a storage apparatus 120. The storage apparatus 120 may be provided inside the monitoring apparatus 100, or may be provided outside the monitoring apparatus 100. In other words, the storage apparatus 120 may be hardware integrated with the monitoring apparatus 100, or may be hardware independent from the monitoring apparatus 100.

A display apparatus 20 is provided to a monitoring center 10. An image to be transmitted from the camera 5 at each of the stations 30 is displayed on the display apparatus 20 by the monitoring apparatus 100. For example, the display apparatus 20 is a liquid crystal display, an organic electro-luminescence (EL) display, or the like. The display apparatus 20 may be hardware integrated with the monitoring apparatus 100, or may be hardware independent from the monitoring apparatus 100. Further, the monitoring apparatus 100 may be a computer provided outside the monitoring center 10, and may remotely execute display control for the display apparatus 20 at the monitoring center 10.

For example, the station 30 is a so-called “unmanned station” where a station worker is not permanently stationed or there is a time period when no station worker is present. In FIG. 3, it is assumed that a public transportation means is a train, and hence a boarding station is the station 30. The public transportation means is not limited to a train, and for example, includes a vehicle such as a bus. In this case, the boarding station is a bus stop. Further, a plurality of boarding stations along a route of the public transportation means may include a manned boarding station.

At least one camera 5 is provided to each of the stations 30. The camera 5 is preferably installed at a position requiring monitoring according to structure of the station 30.

### <Hardware Configuration>

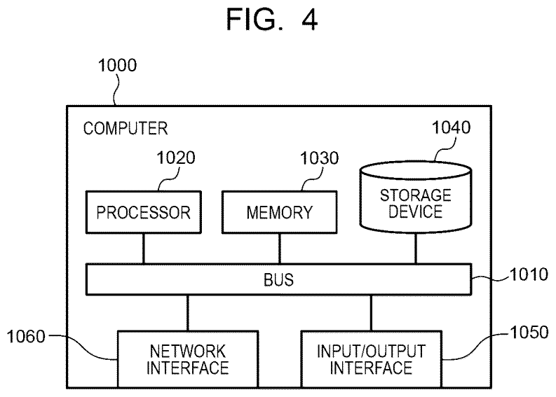

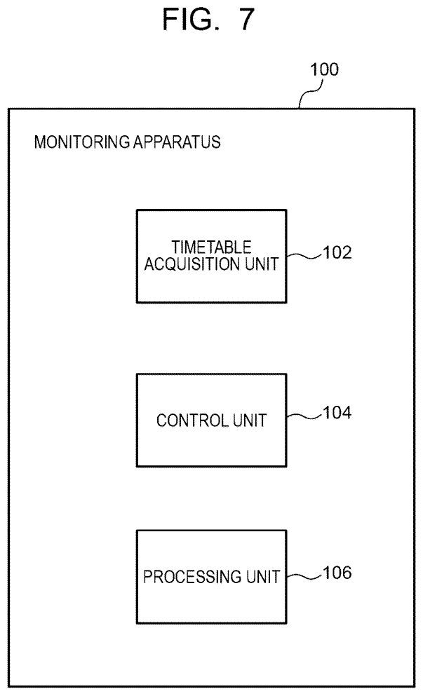

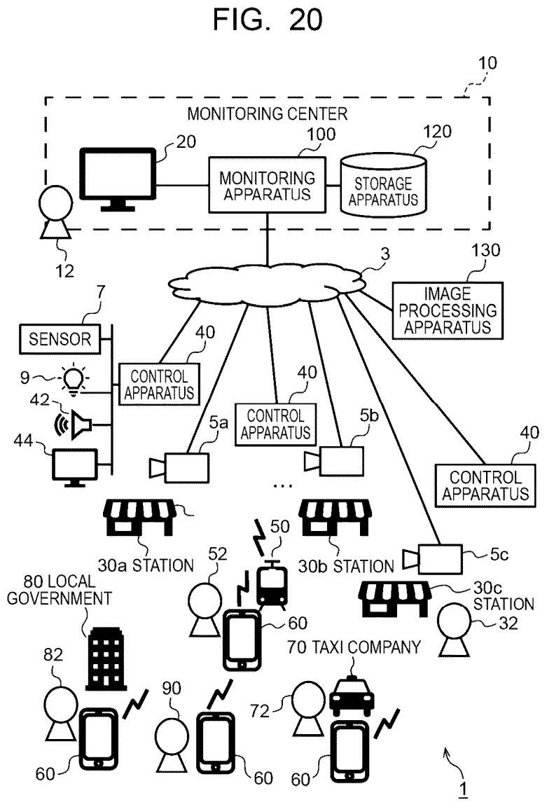

FIG. 4 is a block diagram illustrating a hardware configuration of a computer 1000 that implements the monitoring apparatus 100 in FIG. 1, and FIGS. 7, 11, 14, 16, and 19, which are described later. An operation terminal 60 and a control apparatus 40 in FIG. 20, which are descried later, are also implemented by the computer 1000. Further, the monitoring apparatus 100 may be implemented by a plurality of computers 1000.

The computer 1000 includes a bus 1010, a processor 1020, a memory 1030, a storage device 1040, an input/output interface 1050, and a network interface 1060.

The bus 1010 is a data transmission path in which the processor 1020, the memory 1030, the storage device 1040, the input/output interface 1050, and the network interface 1060 transmit and receive data mutually. However, a method of connecting the processor 1020 and the like to one another is not limited to bus connection.

The processor 1020 is a processor implemented by a central processing unit (CPU), a graphics processing unit (GPU), or the like.

The memory 1030 is a main storage apparatus implemented by a random access memory (RAM), or the like.

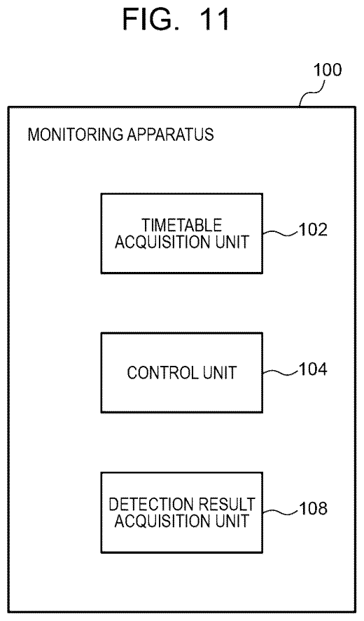

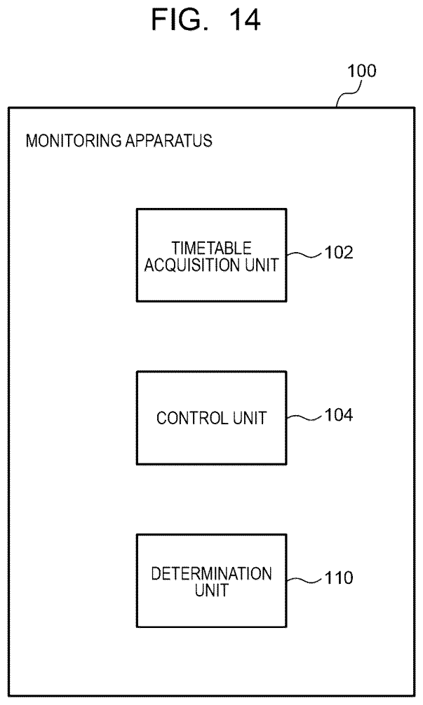

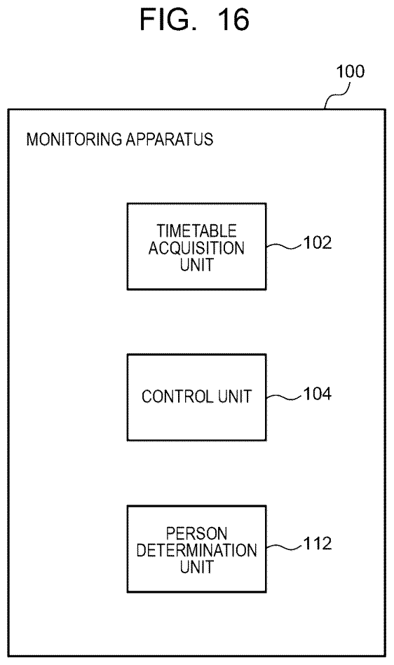

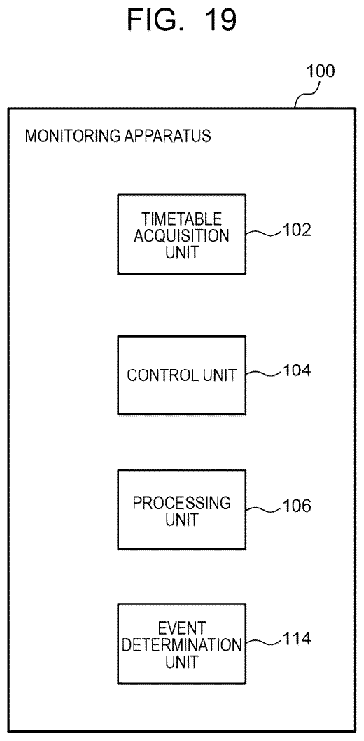

The storage device 1040 is an auxiliary storage apparatus implemented by a hard disk drive (HDD), a solid state drive (SSD), a memory card, a read only memory (ROM), or the like. The storage device 1040 stores a program module achieving each of functions (for example, the timetable acquisition unit 102 and the control unit 104 in FIG. 1, a processing unit 106 in FIG. 7, a detection result acquisition unit 108 in FIG. 11, a determination unit 110 in FIG. 14, a person determination unit 112 in FIG. 16, and an event determination unit 114 in FIG. 19, which are described later, and the like) of the monitoring apparatus 100. The processor 1020 reads each of the program modules on the memory 1030 and executes the program module, and thereby each of the functions associated with each of the program modules is achieved. Further, the storage device 1040 may also store each piece of data of the storage apparatus 120 of the monitoring apparatus 100.

The program module may be stored in a storage medium. The storage medium that stores the program module includes a non-transitory and tangible medium that can be used by the computer 1000, and a program code that can be read by the computer 1000 (the processor 1020) may be embedded in the medium.

The input/output interface 1050 is an interface for connecting the computer 1000 and various input/output devices to each other. The input/output interface 1050 also functions as a communication interface that performs short-range wireless communication such as Bluetooth (registered trademark) and near field communication (NFC).

The network interface 1060 is an interface for connecting the computer 1000 to a communication network. For example, the communication network is a local area network (LAN) or a wide area network (WAN). A method of connecting the network interface 1060 to the communication network may be wireless connection, or may be wired connection.

Further, the computer 1000 is connected to a required device (for example, the camera 5 and the display apparatus 20, a sensor 7, a speaker 42, a display apparatus 44, and a lighting apparatus 46, which are described later, and a keyboard, an operation button, a mouse, a speaker, a microphone, and a printer of the monitoring apparatus 100, which are not shown, and the like) via the input/output interface 1050 or the network interface 1060.

Each of constituent elements of the monitoring apparatus 100 of each of the example embodiments in FIG. 1, and FIGS. 7, 11, 14, 16, and 19, which are described later, is achieved by any combination of the hardware of the computer 1000 in FIG. 4 and software. Further, it is understood by a person skilled in the art that various modification examples may be made to the achievement method and apparatus. A functional block diagram illustrating the monitoring apparatus 100 according to each of the example embodiments illustrates a block in a logical functional unit instead of a configuration of a hardware unit.

### Functional Configuration Example

A functional configuration example of the monitoring apparatus 100 according to the example embodiment is described below with reference to FIG. 1.

A timetable acquisition unit 102 acquires an estimated arrival time of the public transportation means at a boarding station of the public transportation means. As described above, for example, the public transportation means is a train and a bus. The boarding station is a station in a case where a vehicle is a train, and is a stop in a case where the vehicle is a bus.

The timetable acquisition unit 102 may acquire timetable information relating to each of the stations 30 from a website of a public transportation, or may read a data file of timetable information provided by the public transportation.

A control unit 104 controls at least one of the camera 5 being installed at the boarding station and a processing frequency of an image being generated by the camera 5, by using the estimated arrival time.

Controlling the camera 5 includes changing a photographing frequency (for example, the number of times photographing is executed per hour), changing a time for executing photographing and a time interval for stopping photographing (photographing is executed for 30 seconds, and then is stopped for five minutes, or the like), changing a photographing direction or location (switching a platform or a railroad to be photographed), changing a resolution of an image to be photographed (switching between a high-definition mode and a normal mode), changing an angle of view for photographing (switching an angle of view between a wide angle and a normal angle), and the like.

Controlling the processing frequency of an image being generated by the camera 5 includes at least one of changing an image processing frequency, changing a frame rate or a resolution of an image subjected to image processing, and changing at least one of a display interval, a display duration, the number of display times, a display region size, and a display position of an image displayed on the display apparatus 20. However, the processing frequency may differ according to a processing content.

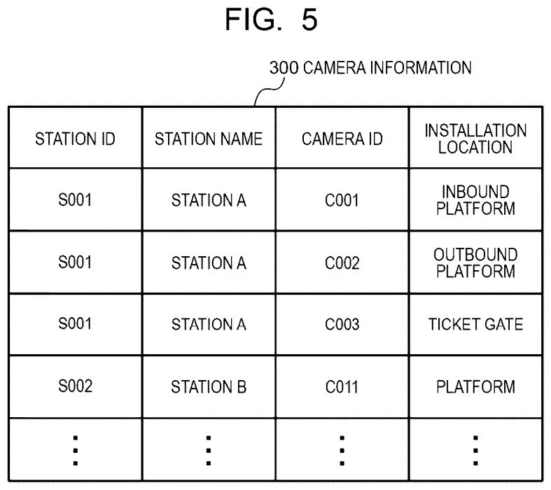

FIG. 5 is a diagram illustrating a data structure example of camera information 300. The camera information 300 includes identification information (station ID) relating to the station 30 at which the camera 5 is installed, a name of the station 30, identification information (camera ID) relating to the camera 5, and information indicating an installation location. For example, the identification information relating to the camera 5 may be an IP address of the camera 5. The information indicating an installation location may be location information on a map inside the station 30.

For example, the monitoring apparatus 100 can acquire an image to be transmitted from the camera 5 at each of the stations 30, by specifying the IP address of the camera 5, and hence can determine from which camera 5 the image being received is transmitted, based on the IP address.

### Operation Example

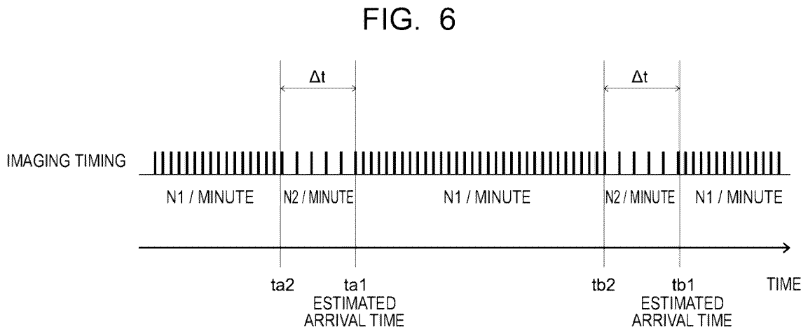

With reference to FIGS. 2 and 6, an operation example of the monitoring apparatus 100 of the example embodiment is described below. FIG. 6 is a diagram illustrating a control example of imaging timing of the camera 5 by the control unit 104.

First, the timetable acquisition unit 102 acquires estimated arrival times ta1, tb1, . . . of a public transportation means at a boarding station of the public transportation means (step S101).

Further, the control unit 104 controls at least one of the camera 5 being installed at the boarding station and a processing frequency of an image being generated by the camera 5, by using the estimated arrival time ta1, tb1, . . . (step S103).

In this example, for example, during a period (Δt) from a time ta2, tb2 . . . , which is a predetermined time prior to the estimated arrival time ta1, tb1, . . . , until the estimated arrival time ta1, tb1, . . . , the control unit 104 executes control in such a way that an imaging frequency of the camera 5 (the number of imaging times N2 per minute) is lower than an imaging frequency of the camera 5 (the number of imaging times N1 per minute) during other periods (for example, a period from the time ta1 to the time tb2 in FIG. 6). Herein, the number of imaging times N1 is greater than N2.

For example, the predetermined time is ten minutes or the like. A plurality of predetermined times may be set, and different imaging frequencies may be set for two periods, specifically, ten minutes and five minutes. For example, control may be executed in such a way that the imaging frequency of the camera 5 at timing five minutes prior to the estimated arrival time is lowered than that at timing ten minutes prior thereto. The reason for this is that a monitoring system by the camera 5 at the station 30 may be relaxed since a plurality of users visit the station 30 before the arrival time of the public transportation means.

A usage condition at the station 30 may be determined by analyzing a video of the camera 5, a time at which a plurality of users gather at the station 30 may be determined, and the time being determined may be set as the predetermined time.

Further, a set value for the predetermined time may be changed according to a time period. For example, the predetermined time may be set to ten minutes in a commuting time period, and the predetermined time may be set to five minutes in other time periods. Further, the set value for the predetermined time may be changed according to a day of the week. For example, the predetermined time may be five minutes on weekdays, and may be ten minutes on weekends. The predetermined time may be set for each of conditions acquired by combining a plurality of conditions, which are described above, with each other.

Further, a set value for the processing frequency may also be set for each of conditions. For example, the processing frequency in a commuting time period may be set lower compared with that in other time periods.

According to the present example embodiment described above, the monitoring apparatus 100 includes the timetable acquisition unit 102 and the control unit 104. The timetable acquisition unit 102 acquires an estimated arrival time of a public transportation means at a boarding station of the public transportation means. The control unit 104 controls at least one of a camera being installed at the boarding station and a processing frequency of an image being generated by the camera, by using the estimated arrival time.

With this configuration, at a predetermined time prior to an arrival time of the public transportation means, a plurality of user gather at the station 30, and hence at least one of the camera 5 and the processing frequency of the image being generated by the camera 5 is lowered. In other words, during this period, a monitoring system at the station 30 is reinforced. At a time in which a user is not present at the station 30, at least one of the camera 5 and a first processing frequency being generated by the camera 5 is increased. In other words, during this period, the monitoring system at the station 30 is reinforced. In this manner, according to the monitoring apparatus 100, it is possible to secure safety and security of a user at a boarding station of a public transportation means at a low cost in an efficient and effective manner.

### Second Example Embodiment

FIG. 7 is a functional block diagram illustrating a logical configuration example of a monitoring apparatus 100 of an example embodiment. The present example embodiment is similar to the above-mentioned example embodiment, except a point of including a configuration of displaying a surveillance video on a display apparatus 20 and also controlling a display processing frequency of the surveillance video. In addition to the configuration of the monitoring apparatus 100 in FIG. 1, the monitoring apparatus 100 in FIG. 7 further includes a processing unit 106. Note that, the configuration of the present example embodiment may be combined with at least any one of configurations of other example embodiments without causing any inconsistencies.

### Functional Configuration Example

The processing unit 106 displays, on the display apparatus 20, an image being generated by a camera 5.

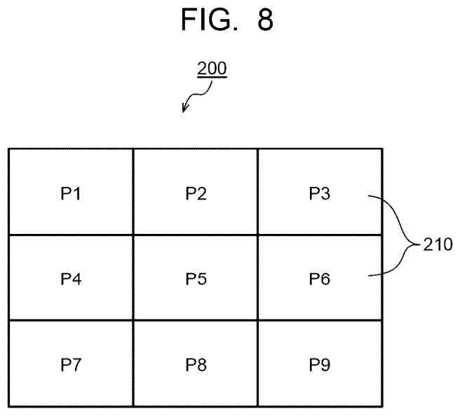

FIG. 8 is a diagram illustrating an example of a monitoring screen 200 being displayed on the display apparatus 20. In the example in FIG. 8, the monitoring screen 200 is divided into a plurality of regions 210. The processing unit 106 displays images (P1 to P9) being generated by each of the cameras 5, in the plurality of regions 210. However, the processing unit 106 may display, on the monitoring screen 200, an image of at least one camera 5.

The processing unit 106 sequentially displays, in the plurality of regions 210 on the display apparatus 20, images of the plurality of cameras 5 for a predetermined display duration and at a display interval.

Further, imaging timing in FIG. 6, which is described in the above-mentioned example embodiment, can be replaced as timing at which an image being generated by each of the cameras 5 at a station 30 is displayed on the display apparatus 20. In other words, a control unit 104 changes a processing frequency at which an image is displayed on the display apparatus 20, during a predetermined time prior to an arrival time of a public transportation means and during other periods. Specifically, the control unit 104 lowers a display frequency during a period from a time being the predetermined time prior to an estimated arrival time until the estimated arrival time, as compared to those in other periods.

The processing unit 106 displays an image being generated by the camera 5, on the display apparatus 20, at the display frequency being controlled by the control unit 104. Further, the processing unit 106 processes the image being generated by the camera 5. The image processing, which is described in detail in an example embodiment described later, includes processing such as detection of a person in an image, determination of an attribute of a person, and detection of an event.

The processing unit 106 further displays a processing result of the image on the display apparatus 20. The processing result includes information relating to a content of a person or an event detected in an image, an attribute of the person being determined, and the like.

### Operation Example

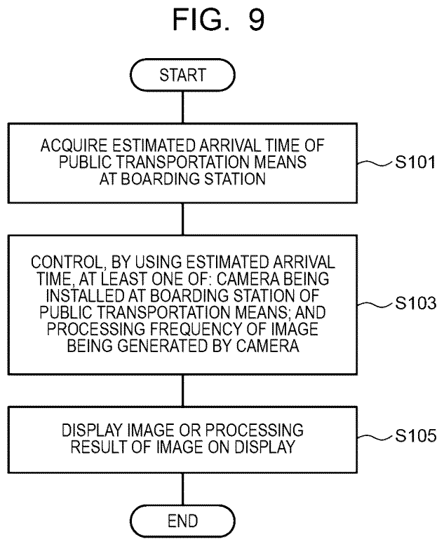

FIG. 9 is a flowchart illustrating an operation example of the monitoring apparatus 100 of the example embodiment. The flow in FIG. 9 further includes step S105, in addition to the flow in FIG. 2.

After at least one of the camera 5 being controlled by the control unit 104 and a processing frequency of an image being generated by the camera 5 is controlled in step S103, the processing unit 106 displays the image or an image processing result on the display apparatus 20 (step S105).

The processing unit 106 controls display on the display apparatus 20, according to the camera 5 or the processing frequency of the image, which is controlled in step S103. For example, a control content of display on the display apparatus 20 includes the number of image display times (for example, the number of display times per minute), a display duration of an image (30 seconds or the like), a display position of an image in a case where the images of the plurality of cameras 5 are displayed on one screen, a frame rate or a resolution of an image to be displayed, and the like.

Note that, the camera 5 or the processing frequency of an image controlled by the control unit 104 and the display control for the image on the display apparatus 20 by the processing unit 106 may match with each other, or may not match with each other.

For example, the processing unit 106 may display an image on the display apparatus 20 at the processing frequency controlled by the control unit 104. Alternatively, the processing unit 106 may display an image on the display apparatus 20 at a processing frequency different from the processing frequency controlled by the control unit 104.

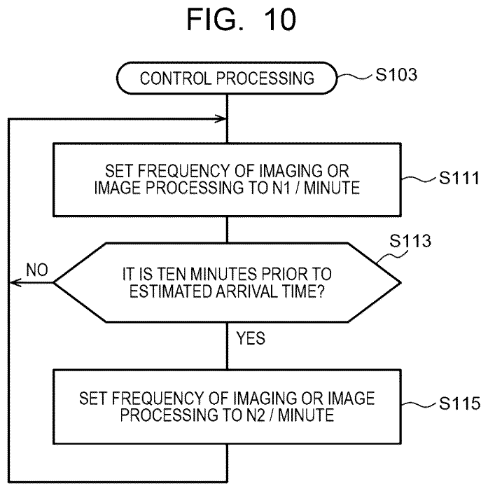

FIG. 10 is a flowchart illustrating a detailed procedure example of control processing (step S103 in FIG. 2) by the control unit 104 of the monitoring apparatus 100 of the example embodiment.

First, the control unit 104 sets a processing frequency of imaging and image processing for an image to N1 per minute in a normal mode (step S111). For example, the processing frequency is three times per minute. The control unit 104 determines whether it is the predetermined time (for example, ten minutes) prior to the estimated arrival time of the public transportation means (step S113). In a case where it is the predetermined time prior to the estimated arrival information (YES in step S113), the control unit 104 sets the processing frequency of imaging and image processing for an image to N2 per minute in a relaxation mode (step S115). For example, the processing frequency is once per minute. In other words, the processing frequency N2 per minute in the relaxation mode is set to a processing frequency lower than the processing frequency N1 per minute in the normal mode.

A monitoring system with the camera 5 is relaxed because persons gather at the station 30 before the estimated arrival time of the public transportation means, and the monitoring system is reinforced because there are few people at the station 30 at other times. In this manner, according to the monitoring apparatus 100 of the example embodiment, the above-mentioned control, by the control unit 104, of the camera 5 or a processing frequency of an image being generated by the camera 5 enables switching the monitoring system between the predetermined period prior to the estimated arrival time of the public transportation means and the other periods. With this, similarly to the above-mentioned example embodiment, it is possible to secure safety and security of a user at a boarding station of the public transportation means at a low cost in an efficient and effective manner.

Further, display processing on the display apparatus 20 can also be controlled. In other words, a display frequency is lowered during the predetermined period prior to the estimated arrival time of the public transportation means whereas the display frequency is increased during the other periods, and hence the monitoring system at the station 30 where there are few people during the periods other than the period prior to the estimated arrival time of the public transportation means can be reinforced.

### Third Example Embodiment

FIG. 11 is a functional block diagram illustrating a logical configuration example of a monitoring apparatus 100 of an example embodiment. The present example embodiment is similar to any of the above-mentioned example embodiments, except a point of including a configuration of acquiring a detection result of a sensor installed at a boarding station and controlling a camera 5 or an image being generated by the camera 5, by using the detection result. In FIG. 11, a detection result acquisition unit 108 is provided in addition to the configuration of the monitoring apparatus 100 in FIG. 1. However, a combination may be made with the second example embodiment in FIG. 7 and other example embodiments described later without causing any inconsistencies.

### Functional Configuration Example

The detection result acquisition unit 108 acquires a detection result of a sensor being installed at the boarding station.

A control unit 104 controls at least one of the camera 5 and a processing frequency of an image, by further using a detection result of a sensor 7.

### System Configuration Example

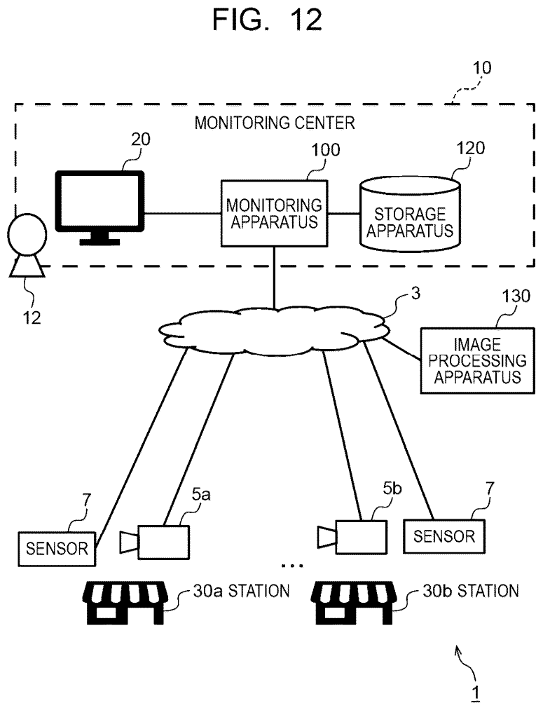

FIG. 12 is a diagram schematically illustrating a system configuration of a monitoring system 1 according to the example embodiment.

In addition to the system configuration of the monitoring system 1 in FIG. 3, the monitoring system 1 further includes the sensor 7 being provided at each of stations 30. Moreover, the monitoring system 1 includes an image processing apparatus 130 that processes an image being generated by the camera 5.

For example, the sensor 7 includes at least one of a motion sensor (for example, an infrared sensor) that detects presence of a person inside the station 30, a depth sensor that detects a foreign object on a railroad, and a sensor that detects pinching at a platform gate.

The image processing apparatus 130 detects presence of a person inside the station 30 or detects presence of a foreign object on a railroad, by processing an image being generated by the camera 5. Thus, the sensor 7 may include the camera 5.

The image processing apparatus 130 may be provided inside the monitoring apparatus 100, or may be provided outside the monitoring apparatus 100. In other words, the image processing apparatus 130 may be hardware integrated with the monitoring apparatus 100, or may be hardware independent from the monitoring apparatus 100.

### Operation Example

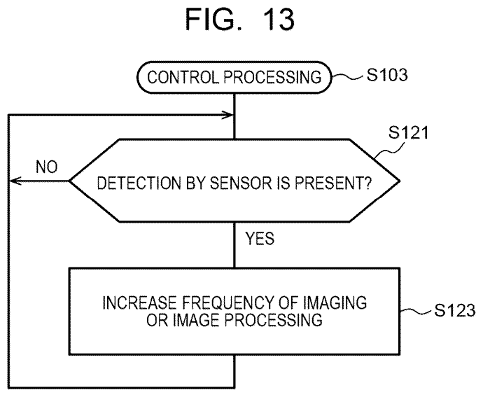

FIG. 13 is a flowchart illustrating a detailed procedure example of control processing by the control unit 104 of the monitoring apparatus 100 of the example embodiment. Before the flow, the detection result acquisition unit 108 acquires a detection result from the sensor 7.

Further, the control unit 104 determines whether the detection result of the sensor 7, which is acquired by the detection result acquisition unit 108, indicates a predetermined event, such as presence of a person, presence of a foreign object, or occurrence of gate pinching (step S121). In a case where detection by the sensor 7 is present (YES in step S121). The control unit 104 increases the camera 5 and a processing frequency of an image being generated by the camera 5 (step S123).

In a case where detection by the sensor 7 is not present (NO in step S121), step S123 is bypassed, and the processing is terminated without changing the processing frequency.

For example, in a case where the sensor 7 detects presence of a person during a period other than a predetermined time prior to an arrival time of a public transportation means, which is described above in the first example embodiment, the control unit 104 further increases the processing frequency. In a case where the sensor 7 detects presence of a person during the predetermined time prior to the arrival time of the public transportation means, which is described above in the first example embodiment, the control unit 104 may not increase the processing frequency, or may increase the processing frequency. For example, this is because it is conceivable that the processing frequency may be reduced in a case where a plurality of persons are detected in an example embodiment described later.

Further, regardless of whether it is during the predetermined time prior to the arrival time of the public transportation means, which is described above in the first example embodiment, in a case where the detection result of the sensor 7 indicates presence of a foreign object on a railroad or occurrence of gate pinching, the control unit 104 increases the processing frequency.

Further, in combination with the second example embodiment described above, in a case where the processing frequency described above is increased, a processing unit 106 also increases a display frequency of an image being generated by the camera 5 at the station 30 on a display apparatus 20, and executes the display.

As described above, in the monitoring apparatus 100 of the present example embodiment, the detection result acquisition unit 108 acquires a detection result of a sensor being installed at a boarding station, and the control unit 104 controls at least one of the camera 5 and a processing frequency of an image, by further using the detection result of the sensor 7. For example, in a case where the sensor 7 detects a person, a case where a foreign object is detected on a railroad, a case where pinching at a platform gate is detected, or the like, processing speed can be increased.

In this manner, according to the monitoring apparatus 100 of the present example embodiment, since an advantageous effect similar to that in the above-mentioned example embodiment can be achieved, and a monitoring system can be reinforcer or relaxed by using a detection result of the sensor 7, and hence it is possible to secure safety and security of a user at a boarding station of a public transportation means more effectively.

### Fourth Example Embodiment

FIG. 14 is a functional block diagram illustrating a logical configuration example of a monitoring apparatus 100 of an example embodiment. The present example embodiment is similar to any of the above-mentioned example embodiments, except a point of including a configuration of determining an attribute of a person in an image by processing the image being generated by a camera 5 and determining a processing frequency by using the attribute. In addition to the monitoring apparatus 100 in FIG. 1, the monitoring apparatus 100 in FIG. 14 further includes a determination unit 110. Note that, the configuration of the present example embodiment may be combined with at least any one of configurations of other example embodiments without causing any inconsistencies.

### Functional Configuration Example

The determination unit 110 determines an attribute of a person in an image by processing the image being generated by the camera 5.

A control unit 104 further uses the attribute of the person being determined to determine the camera 5 or the processing frequency of an image being generated by the camera 5.

In detail, the determination unit 110 causes an image processing apparatus 130 to process an image being generated by the camera 5, and determines an attribute of a person in the image. The attribute of the person to be determined is an attribute subjected to reinforced monitoring. For example, the attribute includes any one of an age being elderly and an age being a child (for example, an infant). Moreover, the attribute may include any one of a person holding a white cane, a person in a wheelchair, a person carrying a stroller, and the like. Moreover, the attribute may include a gender, and may include a female.

In a case where the attribute of the person is determined, the control unit 104 executes control for increasing the camera 5 or the processing frequency of an image being generated by the camera 5.

### Operation Example

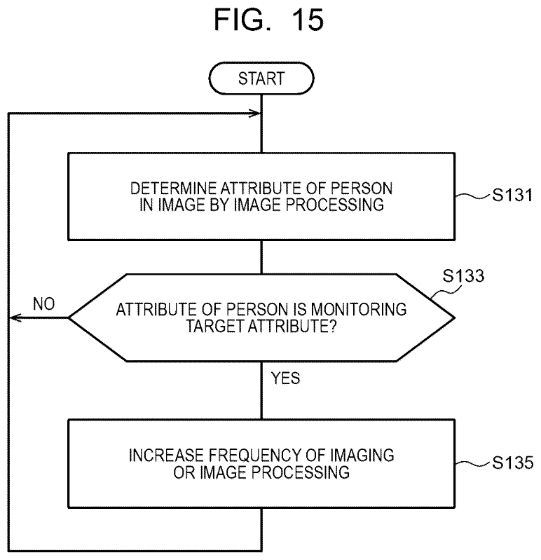

FIG. 15 is a flowchart illustrating an operation example of the monitoring apparatus 100 of the example embodiment. The flow may be executed in parallel with the flow in FIG. 2. First, the determination unit 110 processes an image being generated by the camera 5, and determines an attribute of a person in the image (step S131). In a case where an attribute of a monitoring target is determined (YES in step S133), the control unit 104 increases the camera 5 and the processing frequency of an image to be generated by the camera 5 (step S135). In a case where an attribute of a monitoring target is not determined (NO in step S133), the processing returns to step S131, and is repeated.

For example, in a case where a person included in an image being generated by the camera 5 is determined as an elderly person, the control unit 104 increases the camera 5 and the processing frequency of an image to be generated by the camera 5.

Further, in combination with the second example embodiment described above, in a case where the processing frequency described above is increased, a processing unit 106 also increases a display frequency of an image being generated by the camera 5 at the station 30 on a display apparatus 20, and executes the display.

As described above, in the monitoring apparatus 100 of the present example embodiment, the determination unit 110 determines an attribute of a person in an image by processing the image being generated by the camera 5, and the control unit 104 further uses the attribute of the person being determined to determine the camera 5 or a processing frequency of an image being generated by the camera 5. For example, in a case where the attribute of the person in the image is determined as an elderly person, a person carrying a white cane, a person carrying a stroller, a child, a female, or the like, the processing frequency can be increased.

In this manner, according to the monitoring apparatus 100 of the present example embodiment, since an advantageous effect similar to that in the above-mentioned example embodiment can be achieved, and also a monitoring system can be reinforced or relaxed by using an attribute of a person in an image being determined by image processing, and hence it is possible to secure safety and security of a user at a boarding station of a public transportation means more effectively and more efficiently.

### Fifth Example Embodiment

FIG. 16 is a functional block diagram illustrating a logical configuration example of a monitoring apparatus 100 of an example embodiment. The present example embodiment is similar to any of the above-mentioned example embodiments, except a point of including a configuration of determining whether persons included in an image form a group by processing the image being generated by a camera 5 and determining a processing frequency by using a determination result. In addition to the monitoring apparatus 100 in FIG. 1, the monitoring apparatus 100 in FIG. 16 further includes a person determination unit 112. Note that, the configuration of the present example embodiment may be combined with at least any one of configurations of other example embodiments without causing any inconsistencies.

### Functional Configuration Example

The person determination unit 112 determines whether persons included in an image form a group by processing the image. A control unit 104 further uses a determination result by the person determination unit 112 to determine a processing frequency.

In detail, the person determination unit 112 causes an image processing apparatus 130 to process an image being generated by the camera 5, and determines whether persons included in the image form a group. For example, in a case where a plurality of persons are recognized in an image, it is determined whether the plurality of persons are acquaintances (forming a group) or strangers to each other (being alone), based on whether the persons have a conversation, whether a distance between the persons is equal to or less than a threshold value, or the like.

For example, in a case where the plurality of persons present at the site form a group, it is conceivable that a monitoring system may be relaxed. In contrast, in a case where the plurality of persons present at the site are strangers to each other, it is conceivable that the monitoring system may be reinforced.

In view of this, in a case where the person determination unit 112 determines that persons included in an image form a group, the control unit 104 reduces the camera 5 and a processing frequency of an image to be generated by the camera 5. Alternatively, in a case where the person determination unit 112 determines that persons included in an image do not form a group, the control unit 104 increases the camera 5 and the processing frequency of an image to be generated by the camera 5. At least one of two pieces of processing described above can be executed.

In another example, in a case where count the number of people entering a station 30 is counted by using a detection result of a motion sensor provided at a ticket gate or the like, and it is detected that a predetermined number or more of persons enter, the control unit 104 may reduce the camera 5 and the processing frequency of an image to be generated by the camera 5. Alternatively, in a case where the number of entrants is less than the predetermined number and is a small number, the camera 5 and the processing frequency of an image to be generated by the camera 5 may be increased.

### Operation Example

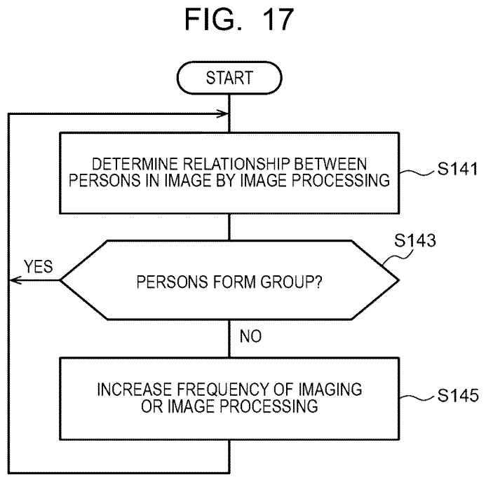

FIG. 17 is a flowchart illustrating an operation example of the monitoring apparatus 100 of the example embodiment. The flow may be executed in parallel with the flow in FIG. 2. Further, the flow may be combined with the flow in FIG. 15. First, the person determination unit 112 determines whether persons included in an image form a group, by processing the image (step S141). In a case where it is determined that the persons do not form a group (NO in step S143), the control unit 104 increases imaging of the camera 5 and the processing frequency of an image to be generated by the camera 5 (step S145). In a case where it is determined that the persons form a group (YES in step S143), the processing returns to step S141, and is repeated.

For example, in a case where it is determined that a plurality of persons included in an image being generated by the camera 5 do not form a group, the control unit 104 increases the camera 5 and the processing frequency of an image to be generated by the camera 5.

As described above, in a case where it is determined that the persons form a group in step S143 (YES in step S143), the control unit 104 may reduce the imaging of the camera 5 and the processing frequency of an image to be generated by the camera 5.

Further, in combination with the second example embodiment described above, in a case where the processing frequency described above is increased, a processing unit 106 also increases a display frequency of an image being generated by the camera 5 at the station 30 on a display apparatus 20, and executes the display. In contrast, in a case where the processing frequency described above is reduced, the display frequency of an image being generated by the camera 5 at the station 30 on the display apparatus 20 may also be reduced, and the display may be executed.

As described above, in the monitoring apparatus 100 of the present example embodiment, the person determination unit 112 determines whether persons included in an image form a group, by processing the image, and the control unit 104 further uses a determination result by the person determination unit 112 to determine the processing frequency. For example, in a case where a plurality of persons included in an image do not form a group, the processing frequency can be increased.

In this manner, according to the monitoring apparatus 100 of the present example embodiment, since an advantageous effect similar to that in the above-mentioned example embodiment can be achieved, and also a monitoring system can be reinforced or relaxed by using a determination result indicating whether a plurality of persons included in an image form a group, based on the image processing, and hence it is possible to secure safety and security of a user at a boarding station of a public transportation means more effectively and more efficiently.

### Sixth Example Embodiment

The present example embodiment is similar to the above-mentioned example embodiment, except a point of including a configuration of changing a processing frequency according to a time until an arrival time, a time period, and the like. Herein, description is made with reference to FIG. 1. However, the configuration of the present example embodiment may be combined with at least any one of configurations of other example embodiments without causing any inconsistencies.

### Functional Configuration Example

A control unit 104 increases a camera 5 and a processing frequency of an image to be generated by the camera 5 as a time until an estimated arrival time of a public transportation means is increased.

This is because a larger number of users gather at a station 30 as a time is closer to the estimated arrival time, and hence a monitoring system can be relaxed. In contrast, as a time until the estimated arrival time is increased, presence of a user at the station 30 is irregular, and requires reinforcing the monitoring system.

Further, a time period in which the processing frequency is to be increased may be set.

The control unit 104 executes control to the processing frequency being set in the time period.

For example, the time period includes a time period in which the number of users is small (for example, during the day or late at night). Further, the time period also includes a predetermined period (ten minutes) prior to the arrival time of the public transportation means, which is described in the above-mentioned example embodiment, and the like.

For example, by subjecting an image of the camera 5 to analysis processing and collecting past statistics, a time (the amount of minutes prior to the arrival time) or a time period in which a large number of users come to take a train of a certain train formation at a certain boarding station may be determined and set. Until the time or the time period (in other words, during a time in which a large number of users do not gather), the processing frequency is set high.

Moreover, the time period in which the processing frequency described above is to be increased may be set for each train formation of the public transportation means. In other words, different time periods may be set according to a destination of the public transportation means, and different types including an express train and a regular train. In other words, it is assumed that an express train has more users regardless of the time period as compared to a regular train whereas it is conceivable that a regular train has fewer users regardless of the time period, and hence the time period in which the processing frequency is to be increased is preferably set for each train formation, based on different criteria.

In the above-mentioned example embodiment, the processing frequency is controlled under various conditions, but the processing frequency may be set by combining those conditions with each other.

### Operation Example

The control unit 104 increases the camera 5 and the processing frequency of an image to be generated by the camera 5 as the time until the estimated arrival time of the public transportation means is increased.

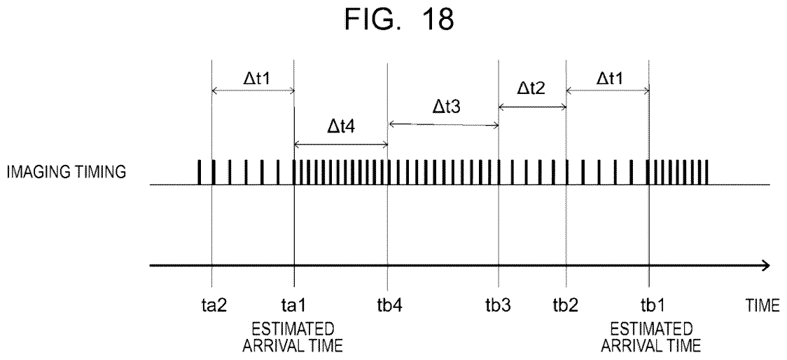

FIG. 18 is a diagram illustrating a control example of imaging timing of the camera 5 by the control unit 104.

During a period Δt1 from times ta2, tb2 . . . prior to the estimated arrival times ta1, tb1, . . . of the public transportation means, a period Δt2 from times ta3 (not shown), tb3 . . . prior to the times ta2, tb2 . . . , a period Δt3 from times ta4 (not shown), tb4 . . . prior to the times ta3 (not shown), tb3 . . . , and a period Δt4 prior to the times ta4 (not shown), tb4 . . . , the processing frequency is set higher as the time until the estimated arrival time is increased.

In this manner, the camera 5 and the processing frequency of an image to be generated by the camera 5 is increased as the time until the estimated arrival time of the public transportation means is increased, and thus monitoring in the time period with few people can be reinforced more.

Further, the control unit 104 acquires the time period in which the processing frequency is to be increased, and increases the processing frequency in the time period. The time period in which the processing frequency is to be increased is a time period in which the number of users is small (for example, during the day or late at night).

As described above, in the monitoring apparatus 100 of the present example embodiment, the control unit 104 increases the camera 5 and a processing frequency of an image to be generated by the camera 5 as a time until the estimated arrival time of the public transportation means is increased. Further, a time period in which the processing frequency is to be increased may be set in advance, and the control unit 104 executes control to the processing frequency being set in the time period. Further, the time period in which the processing frequency is to be increased may be set for each train formation of the public transportation means.

In this manner, according to the monitoring apparatus 100 of the present example embodiment, since an advantageous effect similar to that in the above-mentioned example embodiment can be achieved, and also a processing frequency is increased according to necessity for increasing the processing frequency, and hence it is possible to secure safety and security of a user at a boarding station of a public transportation means more effectively and more efficiently.

### Seventh Example Embodiment

FIG. 19 is a functional block diagram illustrating a logical configuration example of a monitoring apparatus 100 of an example embodiment. The present example embodiment is similar to any one of the above-mentioned example embodiments, except a point of including a configuration of determining presence or absence of a specific event and executing predetermined processing in a case where it is determined that the specific event is present. In addition to the configuration of the monitoring apparatus 100 in FIG. 7, the monitoring apparatus 100 in FIG. 19 further includes an event determination unit 114. Further, the configuration of the present example embodiment may be combined with at least any one of configurations of other example embodiments without causing any inconsistencies.

### System Configuration Example

FIG. 20 is a diagram schematically illustrating a system configuration of a monitoring system 1 according to the example embodiment.

In addition to the system configuration of the monitoring system 1 in FIG. 12, the monitoring system 1 in FIG. 20 further includes a control apparatus 40, a lighting apparatus 9, a speaker 42, and a display apparatus 44 that are provided at each of stations 30. Moreover, in addition to the monitoring system 1 in FIG. 12, the monitoring system 1 in FIG. 20 further includes a manned station 30c. A station worker 32 is present at the manned station 30c.

The monitoring system 1 may further include at least one of a report apparatus (not shown) of a vehicle 50 and an operation terminal 60 operated by a crew member 52 of the vehicle 50, as a report destination in a case where an incident to be reported is detected by the monitoring apparatus 100.

In recent years, it has become increasingly difficult to allocate a cost for maintenance management of an unmanned station, repair for a station building, and the like, and hence it has also become challenging to ensure user safety and convenience. As reorganization of boarding stations progresses, it is desired to ensure safety and convenience at few remaining unmanned stations.

In this context, a system for a local business, a local government, and residents to respond together in a case where an incident to be reported occurs at an unmanned station has been desired. In view of this, in the present example embodiment, the monitoring system 1 may include at least one of the operation terminal 60 operated by a staff member 72 of a taxi company 70, the operation terminal 60 operated by a staff member 82 of a local government 80, and the operation terminal 60 operated by a registered supporter 90 such as a local resident, as a report destination in a case where occurrence of an incident to be reported is detected.

The operation terminal 60 is a computer 1000 such as a smartphone, a personal computer, and a tablet terminal (FIG. 4). Further, the control apparatus 40 may be implemented by the computer 1000 in FIG. 4. For example, the control apparatus 40 includes a control unit (not shown) that controls a sensor 7, the lighting apparatus 9, the speaker 42, and the display apparatus 44 according to an instruction from the monitoring apparatus 100, and a communication unit (not shown) that transmits a state of each of devices to the monitoring apparatus 100. Note that, the control apparatus 40 may be a communication apparatus such as a gateway, and each of the sensor 7, the lighting apparatus 9, the speaker 42, and the display apparatus 44 may be configured to include an IP address and operate directly according to an instruction from the monitoring apparatus 100.

The lighting apparatus 9 is provided at an entrance, a platform, or the like at the station 30, and may turn on the light in a case where the sensor 7 detects presence of a person, may turn off the light in a case where a predetermined time elapses after a departure of a public transportation means, or may be subjected to light-on/light-off control according to a lighting schedule being determined in advance. Such a light-on/light-off operation may be a function included in the lighting apparatus 9 itself, or may be achieved by control of the control apparatus 40 or the monitoring apparatus 100.

The speaker 42 is provided at an entrance, a platform, or the like at the station 30. For example, in a case where the sensor 7 detects presence of a person, a message of a content talking to a user, such as “good morning.”, “hello.”, “good evening.”, and “welcome” may be output as voice sound. With this message, a user can be notified that the monitoring system 1 recognizes presence of a person. For example, for a user alone at the station 30 where there are few people, it is expected that the message provides a sense of security from being watched over. In contrast, it is expected that the message makes a criminal or the like recognize of being monitored and deters the criminal from committing a crime.

A voice sound message being output from the speaker 42 includes various messages such as a message notifying that an arrival is expected soon, a cautionary message to prevent pinching at a platform door and a fall from a platform, and a message indicating a position of a report button, before an arrival time of the public transportation means. Such voice sound output operation is achieved by control of at least one of the control apparatus 40 and the monitoring apparatus 100.

The display apparatus 44 is provided at an entrance, a platform, or the like of the station 30, and may be, for example, a signage such as a liquid crystal display and an organic electro-luminescence (EL) display, or an electronic bulletin board configured by a light emitting diode display device.

On the display apparatus 44, an image including a message similar to the above-mentioned message being output as voice sound may be displayed, or a video or an image indicating a situation where an abnormality occurs may be displayed in a case where the abnormality is detected. Such display operation is achieved by control of at least one of the control apparatus 40 and the monitoring apparatus 100.

In a case where occurrence of an incident to be reported is detected, a report is transmitted to the report apparatus of the vehicle 50, and the operation terminals 60 operated by the crew member 52, the staff member 72 of the taxi company 70, the staff member 82 of the local government 80, and the registered supporter 90.

The report includes information indicating an occurrence date and time of an incident to be reported, an occurrence location (information indicating a station name and a specific occurrence location within the station), and a content of the incident (a fall from a platform, an item unintentionally dropped onto a railroad, pinching at a platform door, sudden illness, fights, luggage lifting, kidnapping, molestation, or the like).

For example, as a notification method, a method in which a specified application is installed in advance in the operation terminal 60 and a notification is issued via the application, or a method of transmitting a message to a predetermined mail address is conceivable.

### Functional Configuration Example

The event determination unit 114 determines presence or absence of a specific event.

A processing unit 106 executes predetermined processing in a case where it is determined that the event is present.

In detail, the event determination unit 114 causes an image processing apparatus 130 to process an image being generated by a camera 5, and thus determines presence or absence of the specific event. Alternatively, the event determination unit 114 may determine presence or absence of the specific event by using a detection result of the sensor 7, which is acquired by a detection result acquisition unit 108 of the above-mentioned example embodiment. Alternatively, the event determination unit 114 subjects sound, which is collected by a microphone (not shown) provided to the station 30, to sound analysis processing, and detects a phrase being typically uttered at a time of a dangerous situation, such as shouting, a scream, a cry, “help”, “watch out”, and “run”, and thereby may determine occurrence of an abnormal situation and determine presence of the event. Note that, the camera 5 may include a microphone, in that case, both a video and voice sound may be generated by the camera 5.

The specific event indicates that an incident to be reported occurs, and includes that at least one of a fall from a platform, an item unintentionally dropped onto a railroad, pinching at a platform door, sudden illness, a fall (and a person who has fallen and is not moving), fights, luggage lifting, a suspicious object, kidnapping, abandonment, molestation, a criminal case, intrusion or presence of a suspicious person, intrusion of a dangerous animal (such as a wild boar, a deer, a bear, a monkey, and a snake), and the like occurs.

The predetermined processing includes processing of notifying a driver or the crew member 52 of the vehicle 50 of the public transportation means being scheduled to arrive next at a boarding station where it is determined that the specific event is present that the event occurs.

In other words, the processing unit 106 outputs an alert to at least one of a speaker (not shown), a display machine (not shown), and a display unit (not shown) of the report apparatus of the vehicle 50 of the public transportation means being scheduled to arrive next at the boarding station where it is determined that the specific event is present. Alternatively, the processing unit 106 may transmit a report message to at least one of the operation terminal 60 of the crew member 52, the operation terminal 60 of the station worker 32 at the other manned station 30a, the operation terminal 60 operated by the staff member 72 of the taxi company 70, the operation terminal 60 operated by the staff member 82 of the local government 80, and the operation terminal 60 operated by the registered supporter 90 such as a local resident, and output an alert.

Further, the predetermined processing may include causing the speaker 42 and the display apparatus 44 at the station 30 to output a message or an alert for notifying that an emergency occurs. Alternatively, the predetermined processing may include processing of closing a ticket gate in order to prohibit entry in the station 30. For example, the control may be executed in such a way as to close a gate of an entrance gate of an automatic ticket gate and keep it close. Alternatively, an indicator light such as a warning beacon at an entrance of the station 30 may be activated. Further, the predetermined processing may include displaying information indicating the closure on the display apparatus 44 (for example, an electronic bulletin board) at the station 30.

However, the alert output may include a means for receiving cancellation from at least one of the crew member 52 who receives a report and visits the unmanned station 30, the station worker 32 at the other manned station 30a, the staff member 72 of the taxi company 70, the staff member 82 of the local government 80, the registered supporter 90 such as a local resident, and the like. For example, the alert may be cancelled by receiving pressing of an operation button that is displayed on the operation terminal 60 and receives an alert cancellation operation.

Further, the event determination unit 114 may determine, as the specific event, that the sensor 7 detects presence of a person. In such a case, for example, the predetermined processing include outputting a message of a content talking to a user, such as “good morning”, “hello”, “good evening”, and “welcome” as voice sound from the speaker 42.

In a case where the sensor 7 detects that a person intrudes the station 30, the processing unit 106 outputs the message described above as voice sound from the speaker 42. With this message, a user can be notified that the monitoring system 1 recognizes presence of a person. For example, for a user alone at the station 30 where there are few people, it is expected that the message provides a sense of security from being watched over. In contrast, it is expected that the message makes a criminal or the like recognize of being monitored and deters the criminal from committing a crime.

As described above, the predetermined processing may include processing of displaying an image being generated by the camera 5 or a processing result of the image on a display apparatus 20.

In addition to a first image being generated by a camera 5a at a certain station 30a or a processing result of the first image, the processing unit 106 further displays, on the display apparatus 20, a second image being generated by a camera 5b being installed at a station 30b being at least another boarding station or a processing result of the second image. Moreover, the processing unit 106 displays the first image and the second image while controlling a display ratio thereof.

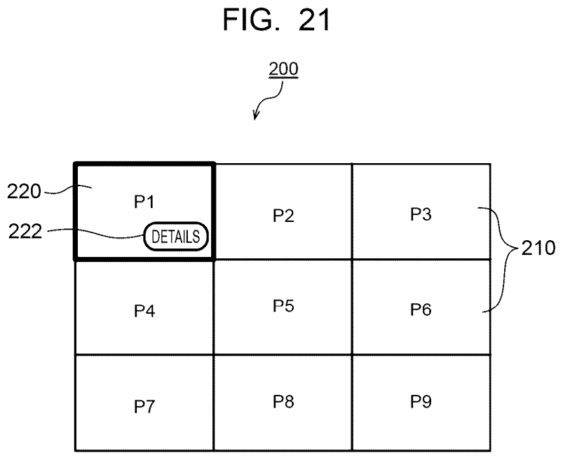

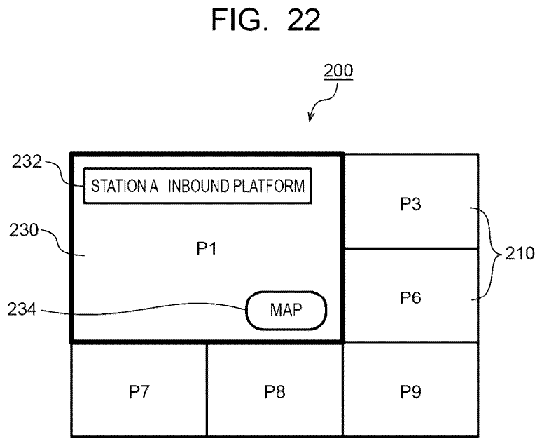

FIGS. 21 and 22 are diagrams illustrating display examples of a monitoring screen 200. The processing unit 106 displays, on the display apparatus 20, the monitoring screen 200 including images being generated by the camera 5 at each of the stations 30, which include an image from which occurrence of the specific event is detected by the event determination unit 114 described above.

The example in FIG. 21 illustrates a scene in which a region 210 of an image P1 of the camera 5 is subjected to highlighted display 220, the camera 5 generating an image from which occurrence of the specific event is detected by the event determination unit 114 described above. For example, the highlighted display 220 includes highlighting the region 210 of the image P1 by changing a color of a frame in the periphery thereof or lighting up the frame (in a flashing manner). Moreover, the monitoring screen 200 may include a detail display button 222. In a case where pressing of the detail display button 222 is received, a screen displaying detail information relating to the specific event is displayed. For example, the detail information may include information such as a name of a station where an event occurs, a location within the station, an occurrence date and time (for example, a photographing date and time of an image frame from which an event is determined), a content of an occurring event, and an emergency level.

The example in FIG. 22 illustrates a scene in which the image P1 of the camera 5 is subjected to highlighted and enlarged display 230, the camera 5 generating an image from which occurrence of the specific event is detected. The highlighted and enlarged display 230 may further include an occurrence position display section 232 and a map display button 234. The highlighted and enlarged display 230 includes a region wider as compared with the regions 210 of other images P3, P6, and the like. Further, similarly to FIG. 21, the frame of the display region may be displayed in a highlighted manner. In the occurrence position display section 232, the information indicating a name of a station where an event occurs, a location within the station, and the like is displayed. The occurrence position display section 232 may further include information such as an occurrence date and time (for example, a photographing date and time of an image frame from which an event is determined), a content of an occurring event, and an emergency level.

In a case where pressing of the map display button 234 is received, the processing unit 106 displays a map of inside of the station that includes information indicating a location where an event occurs. A display screen of the map may be displayed in a window different from the monitoring screen 200, may be displayed by switching from the monitoring screen 200, or may be displayed in a region being a part of the monitoring screen 200. A display mode of the display screen of the map may be changed by an operation of an operator 12.

Further, the processing unit 106 may set display priority order for images being generated by a plurality of cameras 5. As the image has higher priority order, display is controlled to satisfy at least one of that a display duration on the monitoring screen 200 is longer, that a display frequency is higher, that a display ratio is larger (a display area is larger), and that a display position is more prominent. As the image has lower priority order, display is controlled to satisfy at least one of that the display duration on the monitoring screen 200 is shorter, that the display frequency is lower, that the display ratio is smaller (the display area is smaller), and that the display position is less prominent.

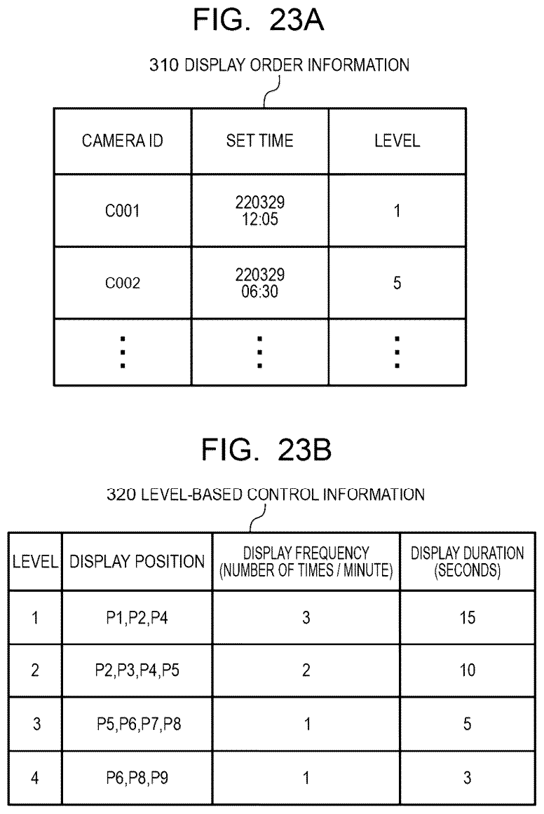

FIG. 23 is a diagram illustrating a data structure example of display order information 310 and level-based control information 320. The display order information 310 and the level-based control information 320 are stored in a storage apparatus 120.

In the display order information 310 in FIG. 23(a), a camera ID and a level indicating the priority order are associated with each other for each of the cameras 5. Moreover, the display order information 310 may further include information (set time) indicating a time at which a level setting is changed.

In the level-based control information 320 in FIG. 23(b), information indicating a display region within the monitoring screen 200, a display frequency (the number of display times per minute or the like), a display duration, and the like are associated with each other for each level indicating the priority order. For example, at the level 1 indicating the highest priority order, a display position of an image is P1, P2, and P4, which are upper left regions within the monitoring screen 200, the display frequency is three times per minute, which is higher than that of other levels, and the display duration is set to 15 seconds, which is longer than that of other levels.

At the level 4 indicating the lowest priority order, the display position of an image is P6, P8, and P9, which are lower right regions within the monitoring screen 200, the display frequency is once per minute, which is lower than that of other levels, and the display duration is set to three seconds, which is shorter than that of other levels. Note that, as described above, the display ratio at the level 1 may be larger than that other images, and the level-based control information 320 may further include an enlargement ratio of the display region (alternatively, a display region ratio or the like) for each level in the level-based control information 320.

For example, the processing unit 106 refers to the display order information 310 and the level-based control information 320, controls the display position, the display frequency, and the display duration of an image on the display apparatus 20 according to the level of each of the cameras 5, and displays the image of each of the cameras 5 on the monitoring screen 200.

In combination with the other example embodiments described above, a control unit 104 may increase or reduce the level according to a condition for increasing or reducing a processing frequency in each of the example embodiments, or may increase or reduce a display frequency according to the processing frequency as a criterion, which is set to the level being set. Alternatively, the processing unit 106 may increase the display duration or increase the display ratio in a case where the processing frequency is increased, or may reduce the display duration or reduce the display ratio in a case where the processing frequency is reduced.

As described above, in the monitoring apparatus 100 of the present example embodiment, the event determination unit 114 determines presence or absence of a specific event, and the processing unit 106 executes predetermined processing in a case where it is determined that the event is present, based on at least one of a detection result of the sensor 7 and image processing of an image being generated by the camera 5. For example, in a case where it is determined that the specific event such as a fall from a platform, an item unintentionally dropped onto a railroad, pinching at a platform door, sudden illness, fights, luggage lifting, kidnapping, molestation, and intrusion of a dangerous animal occurs, the processing unit 106 executes processing of notifying a driver or the crew member 52 of the vehicle 50 of the public transportation means being scheduled to arrive next that the specific event occurs. Alternatively, the processing unit 106 increases a display frequency of an image to be displayed on the display apparatus 20, increases a display duration, or increases a display ratio.

Further, the processing unit 106 executes processing of notifying of occurrence of the specific event to the report apparatus of the vehicle 50, and the operation terminals 60 operated by the crew member 52, the staff member 72 of the taxi company 70, the staff member 82 of the local government 80, and the registered supporter 90.

In this manner, according to the monitoring apparatus 100 of the present example embodiment, an advantageous effect similar to that in the above-mentioned example embodiment can be achieved, and it is possible to secure safety and security of a user at a boarding station of a public transportation means more effectively and more efficiently.

While the example embodiments of the present invention are described above with reference to the drawings, those are examples of the present invention and various configurations other than those described above may be adopted.

For example, while the monitoring screen 200 is displayed on the display apparatus 20 installed at the monitoring center 10 in the above-mentioned example embodiment, the display apparatus 20 may also be installed at the manned station 30c (FIG. 20) in the periphery, for example, and display processing by the processing unit 106 for a surveillance image being generated by the camera 5 at each of the stations 30 may be executed.

While the invention of the present application is described above with reference to the example embodiments, the invention of the present application is not limited to the example embodiments described above. Various modifications that can be understood by a person skilled in the art may be made to the configurations and details of the invention of the present application within the scope of the invention of the present application.

Note that, in the present invention, acquisition and utilization of information relating to a user is done lawfully

Further, in a plurality of flowcharts used in the description given above, a plurality of steps (pieces of processing) are described in order, but the execution order of the steps executed in each of the example embodiments is not limited to the described order. In each of the example embodiments, the order of the illustrated steps may be changed without interfering with the contents. Further, each of the example embodiments described above can be combined with each other within a range where the contents do not conflict with each other.

The whole or a part of the example embodiments described above can be described as, but not limited to, the following supplementary notes.

1. A monitoring apparatus including:
a timetable acquisition unit that acquires an estimated arrival time of a public transportation means at a boarding station of the public transportation means; and
a control unit that controls at least one of a camera being installed at the boarding station and a processing frequency of a first image being generated by the camera, by using the estimated arrival time.

2. The monitoring apparatus according to supplementary note 1, further including:
a detection result acquisition unit that acquires a detection result of a sensor being installed at the boarding station, wherein
the control unit controls at least one of the camera and the processing frequency of the first image, by further using the detection result of the sensor.

3. The monitoring apparatus according to supplementary note 2, wherein
the sensor includes at least one of a motion sensor that detects presence of a person, a depth sensor that detects a foreign object on a railroad, a sensor that detects gate pinching, and a camera that generates an image.

4. The monitoring apparatus according to any one of supplementary notes 1 to 3, further including
a determination unit that determines an attribute of a person in the first image by processing the first image, wherein
the control unit further uses the attribute to determine the processing frequency.

5. The monitoring apparatus according to any one of supplementary notes 1 to 4, further including
a person determination unit that determines whether persons included in the first image form a group, by processing the first image, wherein
the control unit further uses a determination result by the person determination unit to determine the processing frequency.

6. The monitoring apparatus according to any one of supplementary notes 1 to 5, wherein
the control unit increases the processing frequency as a time until the estimated arrival time is increased.

7. The monitoring apparatus according to any one of supplementary notes 1 to 6, wherein
a time period in which the processing frequency is to be increased is set, and
the control unit executes control to the processing frequency being set in the time period.

8. The monitoring apparatus according to supplementary note 7, wherein
the time period is further set for each train formation.

9. The monitoring apparatus according to any one of supplementary notes 1 to 8, further including:
an event determination unit that determines presence or absence of a specific event; and
a processing unit that executes predetermined processing in a case where it is determined that the event is present.

10. The monitoring apparatus according to supplementary note 9, wherein
the predetermined processing includes processing of notifying a driver of a vehicle of the public transportation means that the event occurs, the vehicle being scheduled to arrive next at a boarding station where it is determined that the event occurs.

11. The monitoring apparatus according to supplementary note 9 or 10, wherein
the predetermined processing includes processing of displaying, on a display screen, the first image or a processing result of the first image,
the processing unit further displays, on the display screen, a second image being generated by a camera being installed at least another boarding station or a processing result of the second image together with the first image or a processing result of the first image, and
the processing unit displays the first image and the second image while controlling a display ratio thereof.

12. A monitoring method including,
by one or more computers:
   acquiring an estimated arrival time of a public transportation means at a boarding station of the public transportation means; and
   controlling at least one of a camera being installed at the boarding station and a processing frequency of a first image being generated by the camera, by using the estimated arrival time.

13. The monitoring method according to supplementary note 12, further including,
by one or more computers:
   acquiring a detection result of a sensor being installed at the boarding station; and
   controlling at least one of the camera and the processing frequency of the first image, by further using the detection result of the sensor.

14. The monitoring method according to supplementary note 13, wherein
the sensor includes at least one of a motion sensor that detects presence of a person, a depth sensor that detects a foreign object on a railroad, a sensor that detects gate pinching, and a camera that generates an image.

15. The monitoring method according to any one of supplementary notes 12 to 14, further including,
by one or more computers:
   determining an attribute of a person in the first image by processing the first image; and
   further using the attribute to determine the processing frequency.

16. The monitoring method according to any one of supplementary notes 12 to 15, further including,
by one or more computers:
   determining whether persons included in the first image form a group, by processing the first image; and
   further using a determination result in the determining to determine the processing frequency.

17. The monitoring method according to any one of supplementary notes 12 to 16, further including,
by one or more computers,
   at a time of the controlling, increasing the processing frequency as a time until the estimated arrival time is increased.

18. The monitoring method according to any one of supplementary notes 12 to 17, wherein
a time period in which the processing frequency is to be increased is set,
the monitoring method further including,
by one or more computers,
   at a time of the controlling, executing control to the processing frequency being set in the time period.

19. The monitoring method according to supplementary note 18, wherein
the time period is further set for each train formation.

20. The monitoring method according to any one of supplementary notes 12 to 19, further including,
by one or more computers:
   determining presence or absence of a specific event; and
   executing predetermined processing in a case where it is determined that the event is present.

21. The monitoring method according to supplementary note 20, wherein
the predetermined processing includes processing of notifying a driver of a vehicle of the public transportation means that the event occurs, the vehicle being scheduled to arrive next at a boarding station where it is determined that the event occurs.

22. The monitoring method according to supplementary note 20 or 21, wherein
the predetermined processing includes processing of displaying, on a display screen, the first image or a processing result of the first image,
the monitoring method further including,
by one or more computers:
   further displaying, on the display screen, a second image being generated by a camera being installed at least another boarding station or a processing result of the second image together with the first image or a processing result of the first image; and
   displaying the first image and the second image while controlling a display ratio thereof.

23. A computer-readable storage medium storing a program for causing a computer to execute:
a procedure of acquiring an estimated arrival time of a public transportation means at a boarding station of the public transportation means; and
a procedure of controlling at least one of a camera being installed at the boarding station and a processing frequency of a first image being generated by the camera, by using the estimated arrival time.

24. The storage medium according to supplementary note 23, wherein
the program further causes a computer to execute a procedure of acquiring a detection result of a sensor being installed at the boarding station, and,
in the program, the procedure of controlling controls at least one of the camera and the processing frequency of the first image, by further using the detection result of the sensor.

25. The storage medium according to supplementary note 24, wherein
the sensor includes at least one of a motion sensor that detects presence of a person, a depth sensor that detects a foreign object on a railroad, a sensor that detects gate pinching, and a camera that generates an image.

26. The storage medium according to any one of supplementary notes 23 to 25, wherein
the program further causes a computer to execute a procedure of determining an attribute of a person in the first image by processing the first image, and,
in the program, the procedure of controlling further uses the attribute to determine the processing frequency.

27. The storage medium according to any one of supplementary notes 23 to 26, wherein
the program further causes a computer to execute a procedure of determining whether persons included in the first image form a group, by processing the first image, and
the procedure of controlling further uses a determination result by the procedure of determining to determine the processing frequency.

28. The storage medium according to any one of supplementary notes 23 to 27, wherein,
in the program, the procedure of controlling increases the processing frequency as a time until the estimated arrival time is increased.

29. The storage medium according to any one of supplementary notes 23 to 28, wherein
a time period in which the processing frequency is to be increased is set, and,
in the program, the procedure of controlling executes control to the processing frequency being set in the time period.

30. The storage medium according to supplementary note 29, wherein
the time period is further set for each train formation.

31. The storage medium according to any one of supplementary notes 23 to 30, wherein
the program further causes a computer to execute
a procedure of determining presence or absence of a specific event, and
a procedure of executing predetermined processing in a case where it is determined that the event is present.

32. The storage medium according to supplementary note 31, wherein
the predetermined processing includes processing of notifying a driver of a vehicle of the public transportation means that the event occurs, the vehicle being scheduled to arrive next at a boarding station where it is determined that the event occurs.

33. The storage medium according to supplementary note 31 or 32, wherein
the predetermined processing includes processing of displaying, on a display screen, the first image or a processing result of the first image, and,
in the program,
the procedure of processing further displays, on the display screen, a second image being generated by a camera being installed at least another boarding station or a processing result of the second image, together with the first image or a processing result of the first image, and
the procedure of processing displays the first image and the second image while controlling a display ratio thereof.

### REFERENCE SIGNS LIST

1 Monitoring system
3 Communication network
5, 5a, 5b Camera
7 Sensor
10 Monitoring center
12 Operator
20 Display apparatus
30, 30a, 30b Station (unmanned station)
30c Manned station
32 Station worker
40 Control apparatus
42 Speaker
44 Display apparatus
46 Lighting apparatus
50 Vehicle
52 Crew member
60 Operation terminal
70 Taxi company
72 Staff member
80 Local government
82 Staff member
90 Registered supporter
100 Monitoring apparatus
102 Timetable acquisition unit
104 Control unit
106 Processing unit
108 Detection result acquisition unit
110 Determination unit
112 Person determination unit
114 Event determination unit
120 Storage apparatus
130 Image processing apparatus
200 Monitoring screen
210 Region
220 Highlighted display
222 Detail display button
230 Highlighted and enlarged display
232 Occurrence position display section
234 Map display button
300 Camera information
310 Display order information
320 Level-based control information
1000 Computer
1010 Bus
1020 Processor
1030 Memory
1040 Storage device
1050 Input/output interface
1060 Network interface

What is claimed is:

1. A monitoring apparatus comprising:
at least one memory storing instructions; and
at least one processor configured to execute the instructions to:
acquire an estimated arrival time of a public transportation means at a boarding station of the public transportation means; and
control, by using the estimated arrival time, at least one of a camera being installed at the boarding station and a processing frequency of a first image being generated by the camera.

2. The monitoring apparatus according to claim 1, wherein the at least one processor is further configured to execute the instructions to:
acquire a detection result of a sensor being installed at the boarding station; and
control at least one of the camera and the processing frequency of the first image, by further using the detection result of the sensor.

3. The monitoring apparatus according to claim 2, wherein
the sensor includes at least one of a motion sensor that detects presence of a person, a depth sensor that detects a foreign object on a railroad, a sensor that detects gate pinching, and a camera that generates an image.

4. The monitoring apparatus according to claim 1, wherein the at least one processor is further configured to execute the instructions to:
determine an attribute of a person in the first image by processing the first image; and
further use the attribute to determine the processing frequency.

5. The monitoring apparatus according to claim 1, wherein the at least one processor is further configured to execute the instructions to:
determine whether persons included in the first image form a group, by processing the first image; and
use a determination result determination unit to determine the processing frequency.

6. The monitoring apparatus according to claim 1, wherein the at least one processor is further configured to execute the instructions to
increase the processing frequency as a time until the estimated arrival time is increased.

7. The monitoring apparatus according to claim 1, wherein
a time period in which the processing frequency is to be increased is set, and
the at least one processor is further configured to execute the instructions to
execute control to the processing frequency being set in the time period.

8. The monitoring apparatus according to claim 7, wherein
the time period is further set for each train formation.

9. The monitoring apparatus according to claim 1, the at least one processor is further configured to execute the instructions to:
determine presence or absence of a specific event; and
execute predetermined processing in a case where it is determined that the event is present.

10. The monitoring apparatus according to claim 9, wherein
the predetermined processing includes processing of notifying a driver of a vehicle of the public transportation means that the event occurs, the vehicle being scheduled to arrive next at a boarding station where it is determined that the event occurs.

11. The monitoring apparatus according to claim 9, wherein
the predetermined processing includes processing of displaying, on a display screen, the first image or a processing result of the first image, and
the at least one processor is further configured to execute the instructions to:
further display, on the display screen, a second image being generated by a camera being installed at least another boarding station or a processing result of the second image, together with the first image or a processing result of the first image; and
display the first image and the second image while controlling a display ratio thereof.

12. A monitoring method comprising,
by one or more computers:
acquiring an estimated arrival time of a public transportation means at a boarding station of the public transportation means; and
controlling at least one of a camera being installed at the boarding station and a processing frequency of a first image being generated by the camera, by using the estimated arrival time.

13-15. (canceled)

16. The monitoring method according to claim 12, further comprising,
by one or more computers:
determining whether persons included in the first image form a group, by processing the first image; and
further using a determination result in the determining to determine the processing frequency.

17. The monitoring method according to claim 12, further comprising,
by one or more computers,
at a time of the controlling, increasing the processing frequency as a time until the estimated arrival time is increased.

18-22. (canceled)

23. A non-transitory computer-readable storage medium storing a program for causing a computer to execute:
a procedure of acquiring an estimated arrival time of a public transportation means at a boarding station of the public transportation means; and
a procedure of controlling at least one of a camera being installed at the boarding station and a processing frequency of a first image being generated by the camera, by using the estimated arrival time.

24-26. (canceled)

27. The non-transitory storage medium according to claim 23, wherein
the program further causes a computer to execute a procedure of determining whether persons included in the first image form a group, by processing the first image, and
the procedure of controlling further uses a determination result by the procedure of determining to determine the processing frequency.

28. The non-transitory storage medium according to claim 23, wherein,
in the program, the procedure of controlling increases the processing frequency as a time until the estimated arrival time is increased.

29-33. (canceled)
